(19) United States
(12) Patent Application Publication
(10) Pub. No.: US 2010/0018749 A1
(43) Pub. Date: Jan. 28, 2010

(54) Signal transmission cable protection device

(75) Inventor: Wuu-Lung Wu, Taipei (TW)

Correspondence Address: BACON & THOMAS, PLLC, 625 SLATERS LANE, FOURTH FLOOR, ALEXANDRIA, VA, 22314-1176, US

(73) Assignee: KINPO ELECTRONICS, INC., Taipei (TW)

(21) Appl. No.: 12/222,985

(22) Filed: Aug. 21, 2008

(30) Foreign Application Priority Data
Jul. 24, 2008 (TW) 097128041

(51) Int. Cl. H01B 7/00

(52) U.S. Cl. 174/135

(57) ABSTRACT

A signal transmission cable protection device disposed between an electronic unit main body and a display. The display is freely rotatable within a certain angle range. The signal transmission cable protection device is movable, following the rotation of the display. The signal transmission cable protection device can be easily assembled to provide protection effect for the signal transmission cable. The signal transmission cable protection device includes a cover section. The signal transmission cable is electrically connected between the electronic unit main body and the display and covered by the cover section. By means of the signal transmission cable protection device, the possibility of damage of the signal transmission cable due to human negligence or external force is minimized.

### BACKGROUND OF THE INVENTION

The present invention is related to a signal transmission cable protection device applied to an electronic product, and more particularly to a signal transmission cable protection device disposed between an electronic unit main body and a display for covering the signal transmission cable. The signal transmission cable protection device is movable, following the rotation of the display.

In a conventional electronic unit (such as a computer, a calculator, a digital photo printer, mobile phone, etc.), the display is often pivotally connected to the host via a hinge mechanism such as a pivot shaft or a rotary shaft. Accordingly, the display can be freely rotated to adjust observation angle and located in a fixed angle. Also, the display can be turned and opened or closed. This pertains to prior art. Basically, a signal transmission cable such as a flexible printed circuit (FPC) or a flexible flat cable is arranged between the host and the display. The signal transmission cable serves to electrically connect the display with a motherboard of the host.

In early stage, such FPC or flexible flat cable arranged between the host and the display is often exposed to outer side. In general, some manufacturers will coat the FPC or flexible flat cable with a mylar sheet for protecting the FPC or flexible flat cable. However, such structural configuration leads to an unideal appearance, which is often complained by users. Moreover, with such structural configuration, the FPC or flexible flat cable is likely to be improperly touched or pulled due to human negligence.

Some measures for obviating the above problems have been disclosed. According to these measures, the signal transmission cable or FPC is laid along the pivot shaft or rotary shaft of the hinge mechanism pivotally connected between the host and the display. For example, U.S. Pat. Nos. 6,616,467 B2 and 6,447,315 B1 provide typical embodiments of these measures. However, to those skilled in this field, it is relatively troublesome in manufacturing and assembling process to lay the signal transmission cable or flexible flat cable in the rotary shaft of the hinge mechanism. Especially in the case of a great amount of work pieces, the working time and cost are more apparently increased. This is undesired.

Therefore, some improvements still can be made to the conventional layout of the signal transmission cable such as an FPC or a flexible flat cable connected between the host and display of an electronic product. For example, a signal transmission cable protection device can be applied to the electronic product for protecting the signal transmission cable from damage. This is neither particularly disclosed nor concretely taught in the above Patents.

### SUMMARY OF THE INVENTION

It is therefore a primary object of the present invention to provide a signal transmission cable protection device, which can be easily assembled to provide protection effect for the signal transmission cable. The signal transmission cable protection device is disposed between an electronic unit main body and a display. The display is freely rotatable within a certain angle range. The signal transmission cable protection device is movable, following the rotation of the display. The signal transmission cable protection device includes a cover section. The signal transmission cable is electrically connected between the electronic unit main body and the display. Following the movement of the cover section, the flexible signal transmission cable is flexible to be always covered by the cover section and hidden therein. By means of the signal transmission cable protection device, the possibility of damage of the signal transmission cable due to human negligence or external force is minimized.

It is a further object of the present invention to provide the above signal transmission cable protection device, in which the cover section includes a first cover section and a second cover section pivotally connected with the first cover section. The first cover section has a first end and a second end. The second cover section also has a first end and a second end. The first ends of the first and second cover sections are respectively freely rotatably pivotally connected to the display and the electronic unit main body. The second ends of the first and second cover sections are pivotally connected with each other. Accordingly, the second ends of the first and second cover sections are movable in a set direction, following the rotation of the display.

It is still a further object of the present invention to provide the above signal transmission cable protection device, in which a back section of the display is provided with a cavity and the main body is provided with another cavity. In a non-used state of the display, the first and second cover sections are received in the cavities respectively.

It is still a further object of the present invention to provide the above signal transmission cable protection device, in which the signal transmission cable is laid along an inner face of the first cover section and an inner face of the second cover section.

The present invention can be best understood through the following description and accompanying drawings wherein:

### BRIEF DESCRIPTION OF THE DRAWINGS

FIG. 1 is a perspective view of a preferred embodiment of the signal transmission cable protection device of the present invention;

FIG. 2 is a sectional view of the preferred embodiment of the present invention, showing the operation of the signal transmission cable protection device and the display; and

FIG. 3 is a sectional view of the preferred embodiment of the present invention, showing the relationship between the positions of the signal transmission cable protection device and the signal transmission cable in a non-used state of the display.

### DETAILED DESCRIPTION OF THE PREFERRED EMBODIMENTS

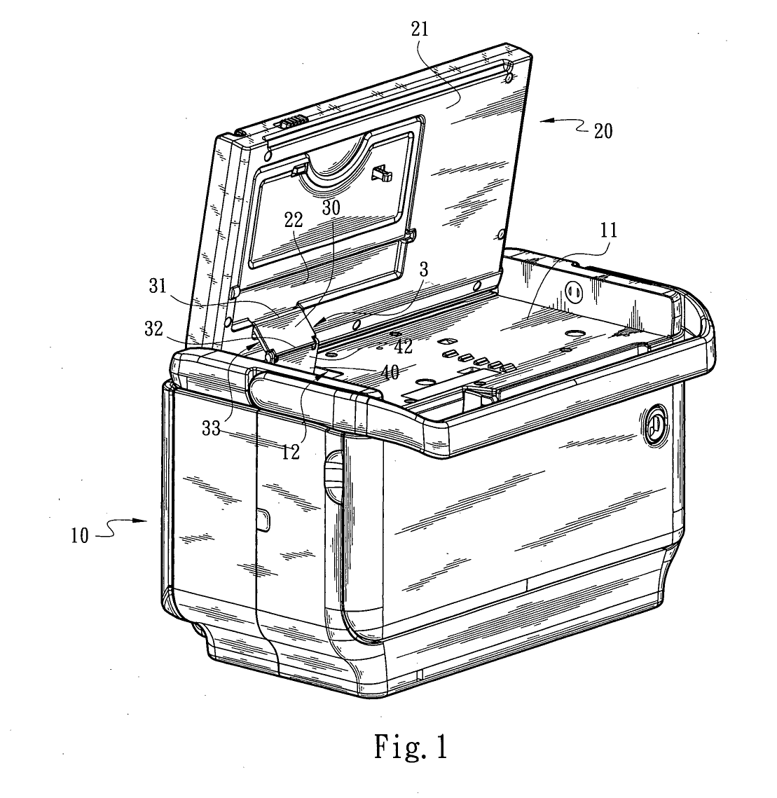

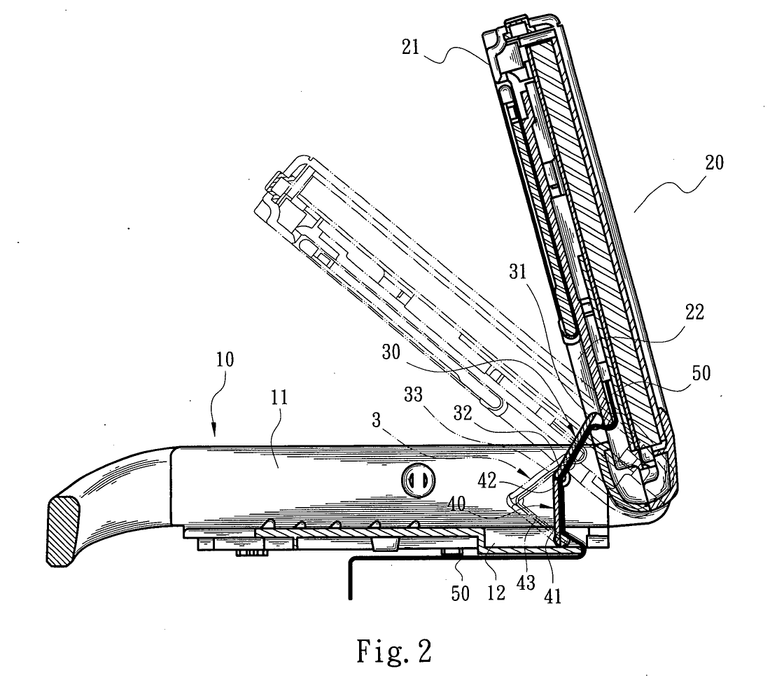

Please refer to FIGS. 1 and 2. The signal transmission cable protection device of the present invention is disposed between an electronic unit main body 10 and a display 20 or a touch panel. The signal transmission cable protection device is movable along with the rotated display 20. The electronic unit main body 10 can be a computer, a calculator, a digital photo printer, etc. The display 20 is mounted on an upper section 11 of the main body 10 via a rotary shaft, a hinge mechanism or the like. Accordingly, the display 20 is freely rotatable within a certain angle range.

Basically, a signal transmission cable 50 is arranged between the main body 10 and the display 20. The signal transmission cable 50 can be a flexible printed circuit (FPC) or a flexible flat cable, which electrically connects the display 20 with a motherboard (not shown) of the main body 10. In a preferred embodiment of the present invention, in order to obviate the troubles in assembling operation and shorten working time, the signal transmission cable 50 is directly connected between the display 20 and the main body 10 over the rotary shaft or the hinge mechanism.

In this embodiment, the signal transmission cable protection device includes a cover section 3. Preferable, the cover section 3 includes a first cover section 30 and a second cover section 40 pivotally connected with the first cover section 30. The first cover section 30 has a first end 31 and a second end 32. The second cover section 40 has a first end 41 and a second end 42. The first ends 31, 41 of the first and second cover sections 30, 40 are respectively freely rotatably pivotally connected to the display 20 and the electronic unit main body 10. The second ends 32, 42 of the first and second cover sections 30, 40 are pivotally connected with each other. Accordingly, the second ends 32, 42 of the first and second cover sections 30, 40 are movable in a set direction, following the rotation of the display 20. This will be further described hereinafter.

Please now refer to FIG. 2. When a user turns open the display 20, following the rotation of the display 20, the first and second cover sections 30, 40 are moved with the signal transmission cable 30 covered by the first and second cover sections 30, 40 until the display 20 is adjusted to a fixed position or a suitable observation angle in a using state. Also, as shown in FIG. 2, the first and second cover sections 30, 40 help to support and hold the display 20 in the fixed position. As aforesaid, the first ends 31, 41 of the first and second cover sections 30, 40 are respectively pivotally connected to the display 20 and the main body 10. This hinders the display 20 from being over-opened due to human negligence.

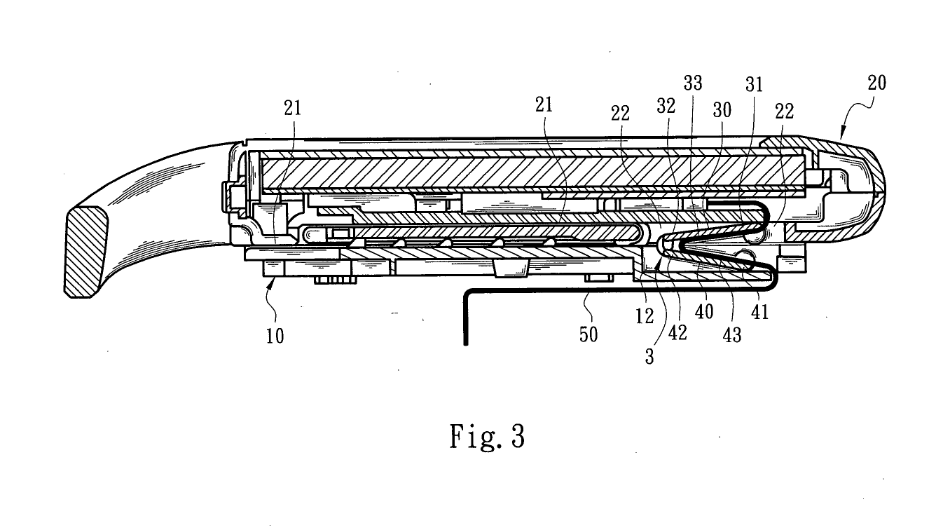

As shown by phantom line of FIG. 2, when the display 20 is turned and closed to the upper section 11 of the main body 10, following the rotation of the display 20, the second ends 32, 42 of the first and second cover sections 30, 40 are moved leftward until the display 20 is fully closed and received in the upper section 11 of the main body 10 (in a non-used state of the display 20) as shown in FIG. 3.

Please again refer to FIGS. 2 and 3, in a preferred embodiment, a back section 21 of the display 20 is provided with a cavity 22 and the main body 10 is provided with another cavity 12. In the non-used state of the display 20, the first and second cover sections 30, 40 are received in the cavities 22, 12 respectively. In a preferred embodiment of the present invention, the signal transmission cable 50 is laid along an inner face 33 of the first cover section 30 and an inner face 43 of the second cover section 40. Following the movement of the first and second cover sections 30, 40, the flexible signal transmission cable 50 is flexible to be always covered by first and second cover sections 30, 40 and hidden therein.

According to the above arrangements, the signal transmission cable protection device of the present invention has the following advantages:
1. In comparison with prior art, the signal transmission cable protection device keeps it convenient to lay the signal transmission cable 50 such as an FPC or a flexible flat cable. Therefore, the troubles in assembling operation can be reduced and the working time can be shortened, especially in the case of a great amount of work pieces. Moreover, the first and second cover sections 30, 40 serve to cover and protect the signal transmission cable 50 so that the possibility of damage of the signal transmission cable 50 due to human negligence or external force is minimized.
2. The first and second cover sections 30, 40 are movable in a set direction, following the rotation of the display 20. It should be noted that the lengths or sizes of the first and second cover sections 30, 40 are modifiable in accordance with the application situations or the sorts of products.
3. When the display 20 is adjusted to a fixed position or a suitable observation angle in a using state, the first and second cover sections 30, 40 also help to support and hold the display 20 in the fixed position. In addition, the first ends 31, 41 of the first and second cover sections 30, 40 are respectively pivotally connected to the display 20 and the main body 10. This hinders the display 20 from being over-opened due to human negligence.

The above embodiments are only used to illustrate the present invention, not intended to limit the scope thereof. Many modifications of the above embodiments can be made without departing from the spirit of the present invention.

What is claimed is:

1. A signal transmission cable protection device disposed between an electronic unit main body and a display, the display being freely rotatable within a certain angle range, the signal transmission cable protection device being movable, following the rotation of the display, the signal transmission cable protection device comprising:
a cover section, the cover section having at least one first end pivotally connected to the main body or the display and an inner face; and
a signal transmission cable electrically connected between the main body and the display, the signal transmission cable being hidden in the cover section.

2. The signal transmission cable protection device as claimed in claim 1, wherein the cover section includes a first cover section and a second cover section pivotally connected with the first cover section, the first cover section having a first end and a second end, the second cover section having a first end and a second end, the second ends of the first and second cover sections being pivotally connected with each other.

3. The signal transmission cable protection device as claimed in claim 2, wherein the first ends of the first and second cover sections are respectively rotatably pivotally connected to the display and the main body.

4. The signal transmission cable protection device as claimed in claim 1, wherein the main body has an upper section provided with a cavity for receiving the cover section.

5. The signal transmission cable protection device as claimed in claim 2, wherein the main body has an upper section provided with a cavity for receiving the cover section.

6. The signal transmission cable protection device as claimed in claim 3, wherein the main body has an upper section provided with a cavity for receiving the cover section.

7. The signal transmission cable protection device as claimed in claim 1, wherein the display has a back section provided with a cavity for receiving the cover section.

8. The signal transmission cable protection device as claimed in claim 2, wherein the display has a back section provided with a cavity for receiving the cover section.

9. The signal transmission cable protection device as claimed in claim 3, wherein the display has a back section provided with a cavity for receiving the cover section.

10. The signal transmission cable protection device as claimed in claim 1, wherein the signal transmission cable is laid along the inner face of the cover section.

11. The signal transmission cable protection device as claimed in claim 2, wherein the signal transmission cable is laid along the inner face of the cover section.

12. The signal transmission cable protection device as claimed in claim 3, wherein the signal transmission cable is laid along the inner face of the cover section.

13. The signal transmission cable protection device as claimed in claim 4, wherein the signal transmission cable is laid along the inner face of the cover section.

14. The signal transmission cable protection device as claimed in claim 5, wherein the signal transmission cable is laid along the inner face of the cover section.

15. The signal transmission cable protection device as claimed in claim 6, wherein the signal transmission cable is laid along the inner face of the cover section.

16. The signal transmission cable protection device as claimed in claim 7, wherein the signal transmission cable is laid along the inner face of the cover section.

17. The signal transmission cable protection device as claimed in claim 8, wherein the signal transmission cable is laid along the inner face of the cover section.

18. The signal transmission cable protection device as claimed in claim 9, wherein the signal transmission cable is laid along the inner face of the cover section.
